(19) United States
(12) Patent Application Publication
(10) Pub. No.: US 2021/0213735 A1
(43) Pub. Date: Jul. 15, 2021

(54) DETECTING FLYING LIQUID DROPS

(71) Applicant: HEWLETT-PACKARD DEVELOPMENT COMPANY, L.P., Spring, TX (US)

(72) Inventors: Oriol BORRELL CARBONELL, Sant Cugat del Valles (ES); Oscar MOYA, Sant Cugat del Valles (ES); Luis Miguel BRUGAROLAS, Sant Cugat del Valles (ES)

(73) Assignee: HEWLETT-PACKARD DEVELOPMENT COMPANY, L.P., Houston, TX (US)

(21) Appl. No.: 16/089,540

(22) PCT Filed: Apr. 24, 2017
(86) PCT No.: PCT/US2017/029061

§ 371 Date: Sep. 28, 2018

(51) Int. Cl. B41J 2/125; B41J 2/165; B41J 2/21; G01N 21/85

(52) U.S. Cl. CPC B41J 2/125; B41J 2/16579; G01N 2021/8564; G01N 21/85; B41J 2/2142

(57) ABSTRACT

A printer comprises a print head comprising nozzles to selectively deposit liquid drops to selected portions of a receiving surface, a radiation light source to supply first light to the receiving surface, and a drop detector. The drop detector detects a flying liquid drop ejected by one of the nozzles and comprises a detector light source to emit a light beam of second light and a light detector to detect the light beam of the second light. The second light is distinguishable by the drop detector from the first light.

### BACKGROUND

Some printers may deposit liquid drops onto a receiving surface. The liquid drops may be ejected by nozzles. Drop detectors may be provided to detect drops ejected by the nozzles to check which of the nozzles are blocked.

### BRIEF DESCRIPTION OF THE DRAWINGS

Examples will now be described, by way of non-limiting examples, with reference to the accompanying drawings, in which:

FIG. 1 shows a schematic illustration of a printer according to an example;

FIG. 2A shows an intensity distribution of light of a fusing lamp and possible wavelengths at which a drop detector operates according to an example;

FIG. 2B shows an intensity distribution of light of a fusing lamp according to an example;

FIG. 3A shows an example of a drop detector comprising a filter in front of an optoelectronic transducer;

FIG. 3B shows a characteristic of an example of a filter in front of an optoelectronic transducer;

FIG. 3C shows a schematic illustration of a drop detector according to an example;

FIG. 4 is a simplified illustration of a 3D printer according to an example; and

FIG. 5 is a flow diagram outlining a method according to an example.

### DETAILED DESCRIPTION

Some printers may eject liquid drops (droplets) through nozzles towards a receiving surface to selectively deposit the liquid drops on the receiving surface. 2D printers may deposit printing liquid drops onto a print medium, such as paper or transparency, to form marks, such as images or text, on the print medium. 3D printers may selectively deposit a print agents, such as coalescing or fusing agents, to a layer of build material, such as powder-based material, in 2D printing, light from a radiation light source may be supplied to the receiving surface on which the printing liquid drops were deposited in order to perform a heat treatment of the printing liquid or an UV illumination in case of an UV curable printing liquid, such as ink. In 3D printing, light from a radiation light source, such as a fusing lamp, may be supplied to the receiving surface in order to solidify portions of the build material, on which some of the printing liquid drops were deposited.

Drop detectors may be provided to detect drops ejected from the nozzles. In general, a drop detector may include a detector light source emitting a light beam and a light detector detecting the emitted light beam. The light detector may be arranged on the far side of the detector light source with respect to a drop ejected by a nozzle, wherein the light beam may be positioned such that when the drop passes by and interrupts the light beam, the light detector registers a decrease in the amount of light. The light detector may be arranged on the same side as the detector light source and may detect reflected light. The quality, quantity, intensity or amount of light falling on the light detector is a measure whether a drop has passed the light beam and may be a measure of the volume or amount of the drop. Accordingly, liquid drops can be detected by evaluating the light impinging on the light detector. Detecting a liquid drop ejected by a nozzle may enable determination whether the nozzle operates properly.

Examples provide a printer comprising a print head comprising nozzles to selectively deposit liquid drops to selected portions of a receiving surface, a radiation light source to supply first light to the receiving surface on which the liquid drops were deposited and a drop detector to detect a flying liquid drop ejected by one of the nozzles. The drop detector comprises a detector light source to emit a light beam of second light and a light detector to detect the light beam of second light. The second light is distinguishable from the first light.

The second light used by the drop detector is distinguishable from the first light. Thus, detection of the second light by the light detector may take place while disturbance of the light detector caused by the first light may be reduced or at best avoided completely.

In examples, the first and second lights comprise different characteristics, such as wavelengths and polarizations, so that same are distinguishable. Accordingly, the drop detector may perform drop detection while the radiation light source is irradiating the receiving surface.

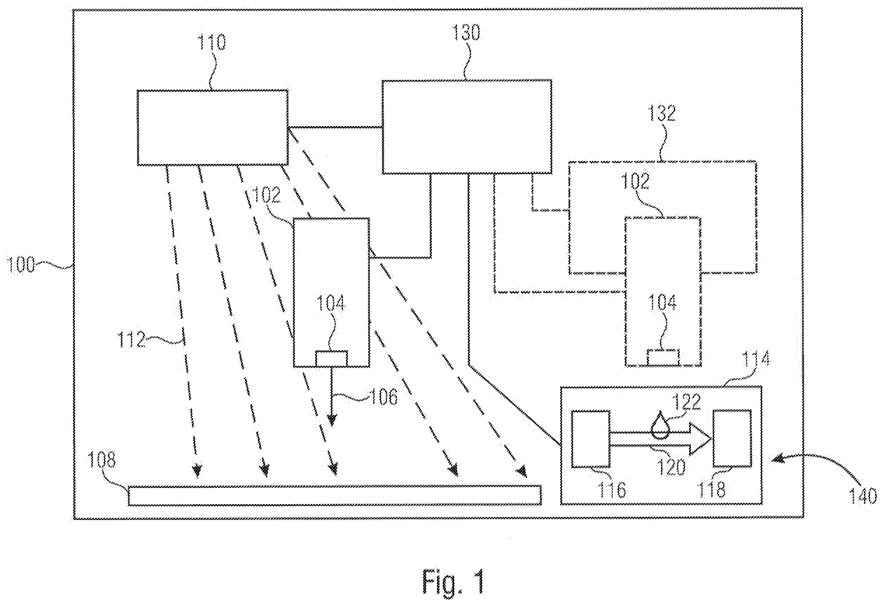

FIG. 1 shows a schematic view of a printer 100 according to an example. The printer 100 comprises a print head 102. The print head 102 comprises an array of nozzles 104. The array of nozzles may be formed in a nozzle plate. The nozzles 104 are to deposit liquid drops onto a receiving surface 108. The printer 100 comprises a radiation light source 110 to supply first light 112 to the receiving surface on which liquid drops were deposited. The printer 100 comprises a drop detector 114 to detect drops ejected from the nozzles. The drop detector 114 comprises a detector light source 116 and a light detector 118. The detector light source 116 is to emit a light beam 120 of second light and the light detector 118 is arranged to receive the light beam 120. A liquid drop 122 passing the light beam 120 results in a decrease of the light detected by the light detector and, therefore, can be detected by drop detector 114.

The printer 100 may include a controller 130 which is coupled to the radiation light source 110, the print head 102 and the drop detector 114 to control the operation thereof. As shown in broken lines in FIG. 1, the printer 100 may comprise a carriage 132 and the controller 130 may control the carriage 132 to move the print head 104 to the position shown in broken lines in FIG. 1. In this position, nozzle 104 is arranged to eject the drop 122 through the light beam 120. The controller 130 may control the print head 102 to eject the flying liquid drop 122 from the nozzle 104 through the light beam 120 of the second light. The controller 130 may determine based on the output of the light detector 118 whether the nozzle 104 is blocked. The controller 130 may derive additional information from the output of the light detector 118, such as on the volume or amount of liquid in the drop. This procedure may be repeated successively for all nozzles of the array of nozzles. In other words, the controller 130 may cause the print head 104 to eject successively a flying liquid drop from each of the nozzles through light beam 120. Thus, drop detector 114 and controller 130 may determine which nozzles of the array of nozzles are blocked. Controller 130 may take corrective measures to correct defects this may cause on the printed element. In examples, the controller may cause another nozzle to replace a blocked nozzle. In examples, the controller may adjust the quantity of servicing to be done to recover blocked nozzles.

In examples, the drop detector 114 is arranged in a drop detector station 140 which is spatially separate from the receiving surface 108. in examples, the print head 104 may be movable by the carriage 132 in a plane which is parallel to the receiving surface 108 to be able to selectively supply drops to any position of the receiving surface 108. The area in which the print head 104 is movable to supply drops to the receiving surface represents a print area. In examples, the drop detector station 140 is arranged laterally beside the print area, i.e. laterally beside the receiving surface 108. The drop detector station may include a spitting pool or spitting surface to receive the drops ejected during drop detection. The drop detector station 140 may not be shielded from light from the radiation light source 110. The controller 130 may control the carriage 132 to move the print head 102 to the drop detector station 140.

The detector light source 116 is to emit the second light and the light detector 118 is to selectively respond to the second light. In other words, a first responsivity of the light detector 118 with respect to the second light may be larger than a second responsivity of the light detector with respect to the first light. The first responsivity may be orders larger than the second responsivity. In other words, the influence of the second light to the output of the light detector 118 is larger than the influence of the first light to the output of the light detector 118. In examples, the light detector 118 may comprise a transducer to selectively convert the second light into an electrical signal. In examples, the light detector 118 may comprise a filter to block the first light and to let the second light pass.

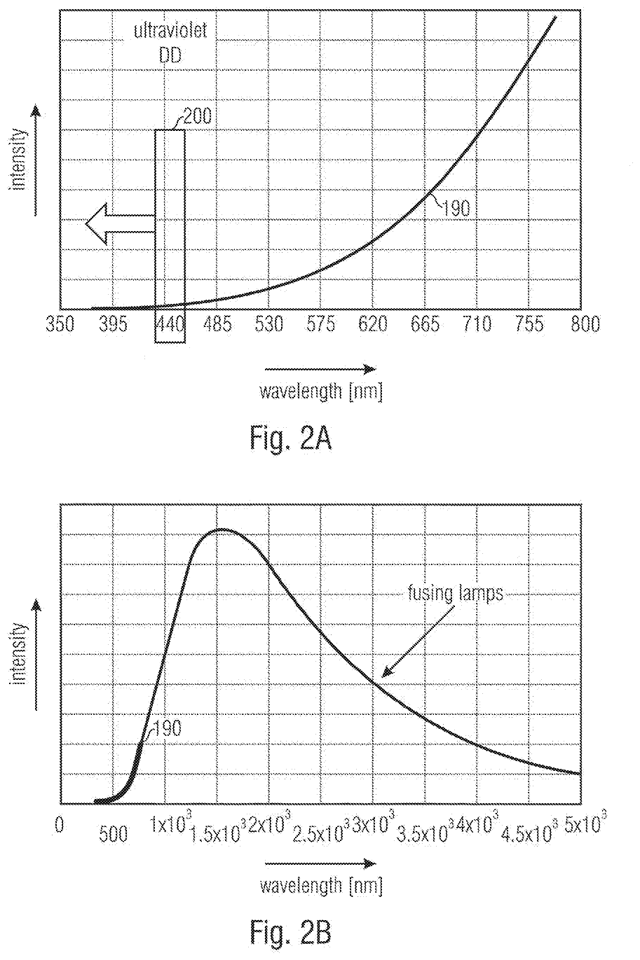

In examples, the first light is in a first wavelength region and the second light is in a second wavelength region different form the first wavelength region. In examples, the second light is a wavelength region of less than 500 nm while the first light is in a wavelength region including wavelengths larger than ultraviolet light, such as wavelengths of more than 500 nm. In examples, the first light includes wavelengths within the visible and infrared light range. FIG. 2B shows a light intensity profile 190 of first light emitted by a radiation light source such as a fusing lamp (curing lamp) of a 3D printer. As it is shown in FIG. 2B. intensity of the first light at wavelengths below 500 nm is negligible. In examples, drop detector 14 may use light comprising wavelengths below 500 nm. Possible wavelengths for the second light are indicated in FIG. 2A by a rectangle 200. As shown by an arrow in FIG. 2A, the wavelength of the second light may be shifted to lower wavelengths, such as to an ultraviolet wavelength region well below 500 nm.

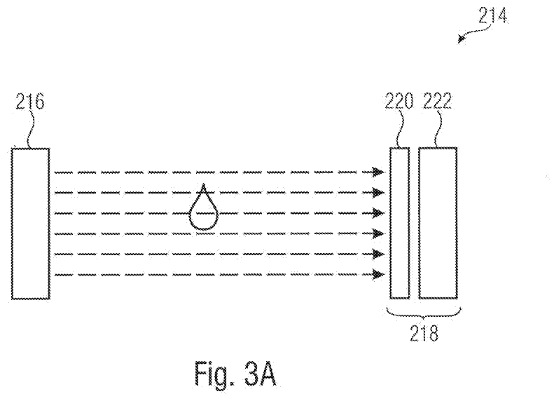

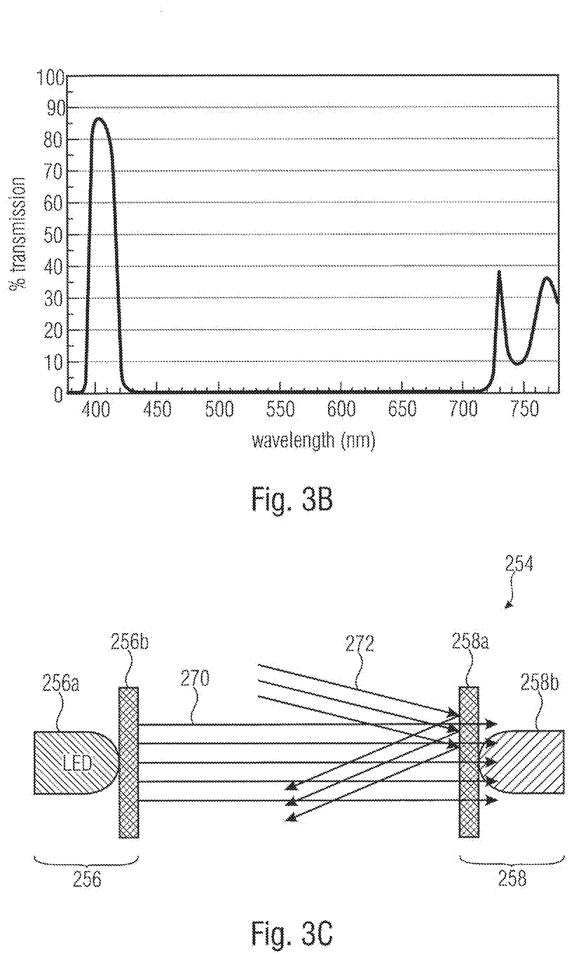

In examples, the light detector may comprise a transducer to convert light into an electrical signal and a filter, such as a band pass filter, provided in front of the light detector FIG. 3A shows a drop detector 214 comprising a light source 216 and a light detector 218 comprising a filter 220 and a transducer 222. The transducer 222 may comprise a photodiode. The transducer may be to selectively convert the second light or may not be selective to the second light. The filter 220 may be to block the first light. The filter 220 may be a low pass filter or a band pass filter. The filter may maximize the effect of blocking the light coming from the first light source. FIG. 3B shows a possible characteristic of an example of a band pass filter having a transmission band at wavelengths of the second light.

In examples, the second light has a polarization different from the polarization of the first light. In examples, the first light may be non-polarized light and the second light may be polarized light. In examples, the first and second light may have different polarizations such as linear, circular or elliptic polarizations. In examples, the light detector may comprise a polarization filter to block the first light and to pass the second light. FIG. 3C shows a drop detector 254 comprising a detector light source 256 and a light detector 258 according to an example. The detector light source 256 comprises a light emitter 256a, such as a light emitting diode, and a polarization filter 256b downstream of the light emitter 256a. Polarized light representing second light is output by the polarization filter. The light detector 258 comprises a polarization filter 258a and a transducer 258b to convert incident light into electrical signals. The polarization filter 258a is arranged in front of the transducer 222 and may let pass polarized light 270 (i.e. light having the polarization of the second light) while light 272 having other polarizations is blocked.

In examples, the printer is a 3D printer, wherein the liquid drops are agent drops, wherein the receiving surface is a layer of build material, and wherein the first light is supplied to the build material on which the agent was deposited to solidify the build material.

3D printers may fuse parts by radiating light by fusing lamps, which may include top lamps, onto the printing area, at a wide range of wavelengths, such as at wavelengths as shown in FIG. 2B. This light may be reflected inside the printer, i.e. inside a print chamber of the printer, and may saturate the sensors (light detectors) of drop detector(s) if same are sensitive for the light of the fusing lamps. This may result In much noise in the electrical signal generated by the light detectors so that reliable drop detection may no longer be possible. In such a case it would not be possible to perform drop detection while the fusing lamps radiate light, but would be possible at the beginning and at the end of a print job. According to examples of the teaching herein, the drop detector uses light distinguishable from the light used by the fusing lamps. Thus, drop detection is less sensible to the fusing lamps radiation and drop detection is possible while the fusing are radiating. Thus, blocked nozzles can be detected during a print job and corrective measures can be taken even during the print job and can be effective for the rest of the print job. In examples, after printing on each layer of build material, drop detection with respect to all or a part of the nozzles may take place at a drop detection station.

In examples, the detector light source may comprise a light emitting diode to emit light at the wavelengths of the second light. In examples, the detector light source comprises a light emitting diode working at an ultraviolet wavelength of 50 nm to 450 nm. In examples, the light detector may comprise a photodiode or a plurality of photodiodes. The photodiodes may be sensitive to the wavelengths of the second light. In examples, a transducer which is able to selectively convert the second light into an electrical signal may be used as the light detector. In examples, the light detector may comprise a transducer and a filter, wherein the transducer is to convert light (including the second light) into an electrical signal and the filter is impervious to the first light and light-transmissive for the second light. In examples, the filter may comprise a band pass filter which is transmissive for the wavelengths of the second light and which blocks light having wavelengths different from the wavelengths of the second light.

In examples, the printer may comprise a plurality of print heads. In examples, some or each of the print heads may include one array of nozzles or a plurality of arrays of nozzles. In examples, the drop detector may comprise a plurality of detector light sources and a plurality of light detectors. In examples, the drop detector may allow drop detection of drops ejected by a plurality of nozzles In parallel. In examples, a separate drop detector may be provided for each of a plurality of print heads. In examples, a separate drop detector may be provided for each array of nozzles of a print head.

In examples, the printer may comprise a set of print heads that print over a build material formed by powder. The printer may use a set of lamps to heat the powder and a set of drop detectors may be used to check whether the nozzles of the print head work properly. The set of drop detectors may be synchronized with the set of print heads and may provide information on which nozzles are blocked. The printer may correct defects which may be caused on the printed element by blocked nozzles and the printer may influence the quantity of servicing to be done to recover those particular nozzles.

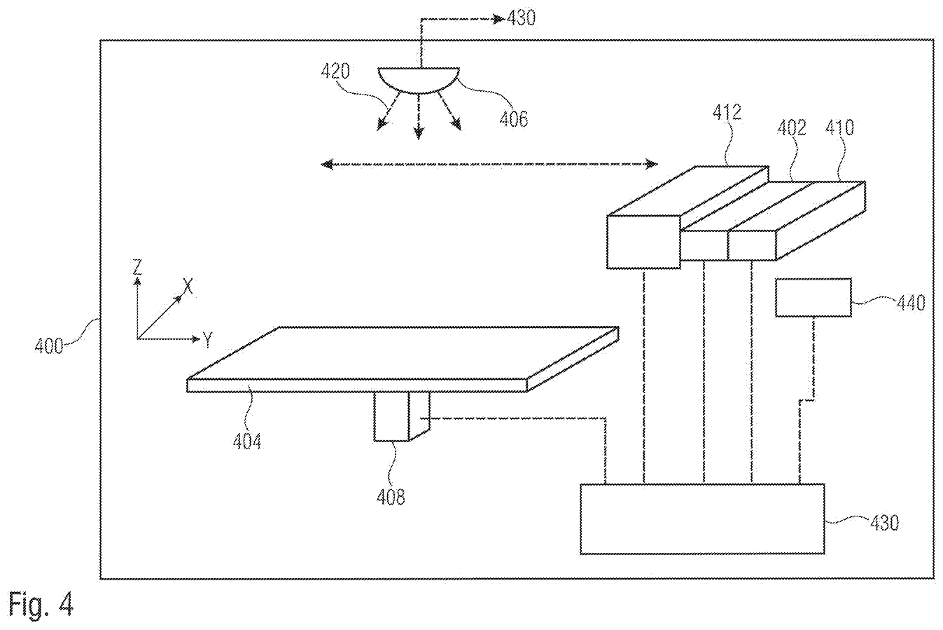

In examples, the printer may be a 3D printer 400 using a coalescing agent technique as described below referring to FIG. 4. The build material used by the 3D printer 400 may be a powder-based build material. The powder-based material may be a dry or wet powder-based material; a particulate material, or a granular material. In some examples, the build material may include a mixture of air and solid polymer particles, for example at a ratio of about 40% air and about 60% solid polymer particles. Other examples of suitable build materials may include a powdered metal material, a powdered composite material, a powder ceramic material, a powdered glass material, a powdered resin material, a powdered polymer material, and combinations thereof. In other examples the build material may be a paste, a liquid, or a gel.

The 3D printer 400 includes a coalescing or fusing agent distributor 402 to selectively deliver a coalescing or fusing agent to successive layers of build material provided on a build platform 404 and an energy source 406 representing a radiation light source. The distributor 402 represents a print head. The build platform 404 may be movable in the direction z via a piston 408. for example, so that the height of the platform 404 relative to the fusing agent distributor 402 may be adjusted depending on the number of layers of build material applied to the build platform 404. A suitable coalescing agent may be an ink-type formulation comprising carbon black. Such an ink may additionally comprise an absorber that absorbs the radiant spectrum of energy emitted by the energy source 406. The agent distributor 402 may be a print head, such as thermal print head or piezo print head. The print head may have arrays of nozzles. The print head may be a drop-on-demand print head. The agent distributor 402 may extend fully across the build platform 404 in a so-called page-wide array configuration. In other examples, the agent distributor 402 may extend across a part of the build platform 404. The agent distributor 402 may be mounted on a moveable carriage to enable it to move bi-directionally across the build platform 404 along the illustrated y-axis. This enables selective delivery of coalescing agent across the entire build platform 404 in a single pass. In other examples, the agent distributor may be moved bidirectionally along both, the illustrated y-axis and the illustrated x-axis. In other examples the agent distributor 402 may be fixed, and the build platform 404 may move relative to the agent distributor 402.

In some examples, there may be an additional coalescing agent distributor 410 representing a further print head. The coalescing agent distributors 402, 410 may be located on the same carriage, either adjacent to each other or separated by a short distance. In other examples, two carriages each may contain the coalescing agent distributors 402, 410. In some examples, the additional coalescing agent distributor 410 may deliver a different coalescing agent than the coalescing agent distributor 402.

The 3D printer 400 further includes a build material distributor 412 to provide, e.g. deliver or deposit, successive layers of build material on the build platform 404. Suitable build material distributors 412 may include a wiper blade and a roller. In the example shown the build material distributor 412 moves along the y-axis of the build platform 404 to deposit a layer of build material. A layer of build material will be deposited on the build platform 404, and subsequent layers of build material will be deposited on a previously deposited layer of build material. In the example shown the build platform 404 is moveable in the z-axis such that as new layers of build material are deposited a predetermined gap is maintained between the surface of the most recently deposited layer of build material and a lower surface of the agent distributor 402. In other examples, however, the build platform 404 may not be movable in the z-axis direction and the agent distributor 402 and the build material distributor 412 may be movable in the z-axis direction.

The energy source 406 applies energy 420 representing first light to the build material to cause a solidification of portions of the build material, for example to portions to which an agent, e.g., the coalescing agent, has been delivered or has penetrated. In some examples, the energy source 406 is a radiation light source emitting light with an intensity distribution as shown in FIG. 2B. In some examples, the energy source 406 applies energy in a substantially uniform manner to the whole surface of a layer of build material, and a whole layer may have energy applied thereto simultaneously, which may increase the speed at which a three-dimensional object may be generated. In other examples, the energy source 406 applies energy in a substantially uniform manner to a portion of the whole surface of a layer of build material. For example, the energy source 406 may apply energy to a strip of the whole surface of a layer of build material. In these examples the energy source 406 may be moved or scanned across the layer of build material such that a substantially equal amount of energy is ultimately applied across the whole surface of a layer of build material. In some examples, the energy source 406 may be mounted on the moveable carriage. In other examples, the energy source 406 may apply a variable amount of energy as it is moved across the layer of build material, for example in accordance with agent delivery control data. For example, a controller 430 may control the energy source 406 to apply energy to portions of build material on which coalescing agent has been applied. The controller 430 may be coupled to the energy source 406, the agent distributors 402, 410, the build material distributor 412 and the piston 408 to control and coordinate the operation thereof.

The 3D printer 400 further comprises a drop detector 440 which may be formed by any of the drop detectors described herein and which may provide the functionality of any of the drop detectors described herein. The drop detector 440 is coupled to the controller. The drop detector 440 may be arranged inside the printer without being shielded against radiation from radiation source 406. As explained herein, the drop detector 440 uses light distinguishable from the light radiated by the radiation source 406 so that drops ejected from nozzles of agent distributors 402, 410 may be detected even at presence of direct or reflected radiation from the radiation source 406.

In examples, the printer is a 2D printer and the the receiving surface is a print medium. In such examples, the liquid may be a printing liquid, such as ink, to print marks on the print medium. The first light may be supplied to the marks to heat treat the marks printed on the print medium. In examples, the first light may be supplied to the marks to cure the printing liquid, such as the ink.

The controllers described herein, such as controllers 130 and 430, may be implemented, for example, by discrete modules (or data processing components) that are not limited to any particular hardware and machine readable instructions configuration. The Controller may be implemented in any computing or data processing environment, including in digital electronic circuitry, e.g., an application-specific integrated circuit, such as a digital signal processor (DSP) or in computer hardware, device driver, or machine readable instructions. In some implementations, the functionalities of the controller are combined into a single data processing component. In other implementations, the respective functionalities may be performed by a respective set of multiple data processing components. In examples, the controller may comprise a processor and a memory device accessible by the processor. The memory device may store process instructions (machine-readable instructions) for implementing methods executed by the controller. The memory device may store instructions to control components of the printing apparatus to perform the methods described herein. The memory device may include one or more tangible machine-readable storage media. Memory devices suitable for embodying these instructions and data include all forms of computer-readable memory, including, for example, semiconductor memory devices, such as EPROM, EEPROM, and flash memory devices, magnetic disks such as internal hard disks and removable hard disks, magneto-optical disks, and ROM/RAM devices. Routines and processes applied to achieve the functionality described herein may be stored in the memory device.

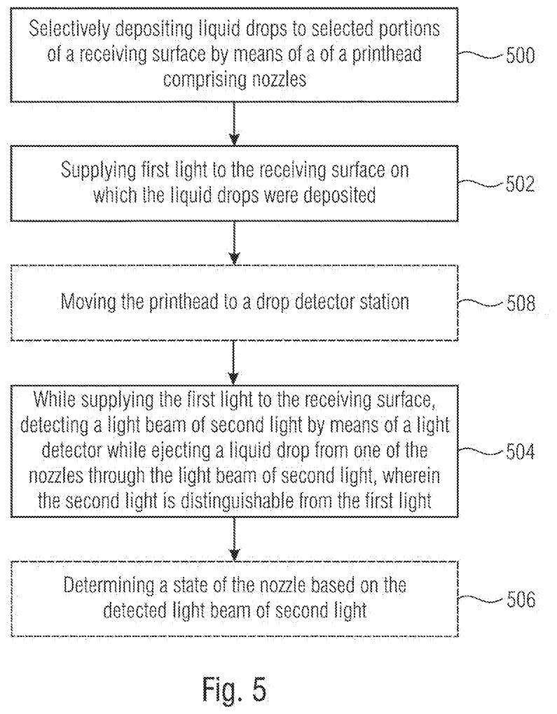

Examples provide a method for detecting drops as shown in FIG. 5. At 500. liquid drops are selectively deposited to selected portions of a receiving surface by a print head comprising nozzles. At 502, first light is supplied to the receiving surface on which the liquid drops were deposited. At 504, while the first light is supplied to the receiving surface, a light beam of second light is detected by a light detector while a liquid drop from one of the nozzles is ejected through the light beam of second light. The second light is distinguishable from the first light. Thus, the liquid drop can be detected. In examples of such a method, the first light is in a first wavelength region and the second light is in a second wavelength region different from the first wavelength region. In examples of such a method, the second light has a polarization different from the polarization of the first light. In accordance with examples of such methods, a state of the nozzle may be determined based on the detected light beam of second light at 506. In accordance with examples of such methods, the print head may be moved to a drop detector station at 508 before ejecting the flying liquid drop through the light beam of second light. The drop detector station may be spatially separate from the receiving surface.

Examples permit drop detectors to be activated during the same time at which a radiation light source supplies light to a receiving surface on which printing took place, which is also referred to as on the fly drop detection. Thus, drop detection may take place during a print job. In examples, the drop detection may be achieved without sealing the drop detector and the print head in a dark volume to keep the radiation of the radiation light source away from the light detector of the drop detector. Thus, in examples, drop detection may be achieved without the mechanical complexity involved in shielding and with less impact on the cycle time of a printer, i.e. the time to engage the drop detector mechanism to the print head or to the carriage supporting the print head. In examples, the state of the nozzles can be checked while printing, i.e. during a print job, so that corrective measures can be taken during the print job in order to avoid finishing the print job using defect nozzles.

Examples described herein relate to the detection of flying liquid drops, such as ink drops, and relate to a way to detect such drops robustly in an environment with large amounts of infrared external light sources or visible external light sources.

In examples, the light detector may comprise a band pass filter which is light-transmissive for the second light and which blocks other light. Background noise and noise caused by light of the radiation source may be reduced using a band pass filter. A band pass filter may be provided in each of the drop detectors described herein. In examples, a band pass filter may be provided in addition to a polarization filter.

Although some aspects of the techniques described herein have been described in the context of an apparatus, these aspects may also represent a description of corresponding method blocks. Analogously, aspects described in the context of a method also represent a description of corresponding blocks or items or features of a corresponding apparatus.

All of the features disclosed in this specification, including any accompanying claims, abstract and drawings, and/or all of the method bocks or processes so disclosed may be combined in any combination, except combinations where at least some of the features are mutually exclusive. Each feature disclosed in this specification, including any accompanying claims, abstract and drawings, may be replaced by other features serving the same, equivalent or similar purpose, unless expressly stated otherwise. Thus, unless expressly stated otherwise, each feature disclosed is one example of a generic series of equivalent or similar features.

1. A printer comprising:
a print head comprising nozzles to selectively deposit liquid drops to selected portions of a receiving surface;
a radiation light source to supply first light to the receiving surface;
a drop detector to detect a flying liquid drop ejected by one of the nozzles, the drop detector comprising a detector light source to emit a light beam of second light and a light detector to detect the light beam of the second light,
wherein the second light is distinguishable by the drop detector from the first light.

2. The printer of claim 1, wherein the printer is a 3D printer, wherein the liquid drops are agent drops, wherein the receiving surface is a layer of build material, and wherein the first light is supplied to the build material on which the agent was deposited to solidify the build material.

3. The printer of claim 1, wherein the printer is a 2D printer, wherein the receiving surface is a print medium, wherein the liquid is a printing liquid to print marks on the print medium, and wherein the first light is supplied to the marks to heat treat or cure the marks printed on the print medium.

4. The printer of claim 1, wherein the first light is in a first wavelength region and the second light is in a second wavelength region different from the first wavelength region.

5. The printer of claim 4, wherein the second light is ultraviolet light

6. The printer of claim 4, wherein the detector light source comprises a filter to let pass light in the second wavelength region and to block light in the first wavelength region.

7. The printer of claim 1, wherein the first light is non polarised light and the second light is polarized light

8. The printer of claim 7, wherein the light detector comprises a polarization filter to block portions of the first light and to pass the second light.

9. The printer of claim 1 comprising a drop detector station spatially separate from the receiving surface and comprising the drop detector, and a carriage to move the print head to the drop detector station after having selectively deposited liquid drops to selected portions of the receiving surface.

10. The printer of claim 1, comprising a controller to cause the print head to eject a flying liquid drop from the nozzle through the light beam of the second light and to determine a state of the nozzle based on the output of the light detector in response to ejecting the flying liquid drop through the light beam of second light.

11. The 3D printer of claim 10, wherein the controller is to cause the print head to eject successively a flying liquid drop from each of the nozzles through the light beam of the second light.

12. A method comprising:
selectively depositing liquid drops to selected portions of a receiving surface by a print head comprising nozzles;
supplying first light to the receiving surface on which the liquid drops were deposited;
while supplying the first light to the receiving surface, detecting a light beam of second light by a tight detector while ejecting a liquid drop from one of the nozzles through the light beam of second light,
wherein the second light is distinguishable from the first light.

13. The method of claim 12, wherein the first light is in a first wavelength region and the second light is in a second wavelength region different from the first wavelength region, or wherein the second light has a polarization different from the polarization of the first light.

14. The method of claim 12, comprising determining a state of the nozzle based on the detected light beam of second light.

15. The method of claim 12, comprising moving the print head to a drop detector station before ejecting the flying liquid drop through the light beam of second light, wherein the drop detector station is spatially separate from the receiving surface.
